(19) United States
(12) Patent Application Publication
(10) Pub. No.: US 2020/0064475 A1
(43) Pub. Date: Feb. 27, 2020

(54) TARGET DETECTING DEVICE AND TARGET DETECTING SYSTEM

(71) Applicant: OMRON AUTOMOTIVE ELECTRONICS CO., LTD., Aichi (JP)

(72) Inventor: Masato Hibino, Aichi (JP)

(73) Assignee: OMRON AUTOMOTIVE ELECTRONICS CO., LTD., Aichi (JP)

(21) Appl. No.: 16/538,956

(22) Filed: Aug. 13, 2019

(30) Foreign Application Priority Data
Aug. 23, 2018 (JP) 2018-156126

(51) Int. Cl. G01S 17/10; G01S 17/93; G01S 7/484; G01S 7/486; G01S 7/481

(52) U.S. Cl. CPC G01S 17/10; G01S 17/936; G01S 7/4817; G01S 7/486; G01S 7/484

(57) ABSTRACT

A target detecting device scans a predetermined range with light emitted from a light emitter, guides the reflected light from a target to a light receiver, and detects the target and dirt on an optical window provided on a case according to the light reception state of the light receiver. Operation patterns of the light emitter and the light receiver differ between target detection and dirt detection, and target detection and dirt detection are separately performed. For example, in a predetermined range scanned with light by a target detecting device, the target detecting device detects dirt on the optical window in a region overlapping with a target detection region of adjacent target detecting device, and detects a target in the other regions.

### CROSS-REFERENCE TO RELATED APPLICATION

This application is based on Japanese Patent Application No. 2018-156126 filed with the Japan Patent Office on Aug. 23, 2018, the entire contents of which are incorporated herein by reference.

### FIELD

The present invention relates to a target detecting device that projects and receives light to detect existence of a target and the distance to the target, and a target detecting system including the target detecting device, and in particular, relates to a technique of detecting dirt on an optical window serving as a light projecting port or a light receiving port of the target detecting device.

### BACKGROUND

A target detecting device such as an in-vehicle laser radar projects light emitted from a light emitter to a predetermined range, and detects existence of a target according to the result of receiving light by a light receiver, the light having been reflected by a target within the predetermined range (for example, JP 2012-192775 A (Patent Document 1)). In addition, there is also a target detecting device that detects the distance to a target according to the time from when a light emitter emits light to when a light receiver receives the reflected light from the target (for example, JP 2005-10094 A (Patent Document 2), JP 2005-227219 A (Patent Document 3), and JP 10-142335 A (Patent Document 4)).

There is a target detecting device including an optical scanner in order to widen the target detection range or to miniaturize the target detecting device (for example, Patent Documents 1 to 3). In this target detecting device, light emitted from a light emitter passes through optical components of a light projecting system such as a transmitter lens and a mirror, and is then reflected by a rotatable mirror provided in the optical scanner to be emitted to the target. At this time, when the mirror of the optical scanner rotates, light from the light emitter is deflected by the mirror of the optical scanner and a predetermined range is scanned. Then, light reflected by the target is reflected by the mirror of the optical scanner, passes through optical components of a light receiving system such as another mirror and a receiver lens, and is then received by the light receiver. Also at this time, when the mirror of the optical scanner rotates, light reflected by the target within the predetermined range is deflected by rotating the mirror of the optical scanner and is guided to the optical components of the light receiving system and the light receiver.

The light emitter is provided with a light emitting element such as a laser diode. A plurality of light emitting elements may be provided in the light emitter in order to project light to a wide range or to increase light projection power. The light receiver is provided with a light receiving element such as a photodiode. In order to receive reflected light from a wide range or to improve light receiving accuracy, a light receiving element having a plurality of light receiving regions may be provided in the light receiver.

Optical-system components and electrical-system components of the target detecting device are housed in a case. The case is provided with an optical window. The optical window is made of light-transmissive material such as glass or resin that transmits light, and serves as a light projecting port or a light receiving port to the inside and outside of the case. The target detecting device is mounted on a vehicle or the like so that the optical window is directed to a predetermined range where a target is detected. Thus, light emitted from the light emitting element and reflected by the mirror of the optical scanner penetrates the optical window and is projected to the predetermined range. In addition, in the light thus projected, the light having been reflected by the target in the predetermined range penetrates the optical window, is reflected by the mirror of the optical scanner, and is received by the light receiving element.

When dirt adheres to the optical window, light emitted from the light emitting element is not projected to the outside, or reflected light from a target located outside does not enter the inside, and thus the target detecting device cannot detect existence of a target, and the like. Therefore, for example, Patent Documents 1 to 4 propose techniques of detecting dirt on an optical window.

In Patent Document 1, dirt on an optical window is detected according to whether or not a light receiving element detects light reflected by a road surface by changing laser beam emission direction from a light emitting element into a vertical downward direction. In contrast, when a target existing in front of, behind, to the right or to the left of a vehicle is detected, a laser beam is projected forward, rearward, to the right, or to the left of the vehicle.

In Patent Document 2, it is determined that there is dirt on condition that among laser beams emitted by a light emitting element, there are a predetermined number or more such laser beams that measurement time from when such laser beams are emitted to when the reflected beams thereof are received is shorter than a predetermined time, and as light receiving pulses of the reflected laser beams further exceed an upper threshold value, the intensity of such laser beams is higher.

In Patent Document 3, a reflecting mirror is provided between an optical window and a light receiving element and is disposed on a line connecting the optical window and the light receiving element and in parallel with the line. Then, the reflecting mirror guides light emitted from the light emitting element and diffusely reflected light due to dirt on the optical window to the light receiving element.

In Patent Document 4, a light emitter for dirt detection is provided in an eaves protruded forward of a case and an optical window. In addition, a light receiver for dirt detection is provided in the case together with a light projector for distance measurement and a light receiver for distance measurement. Then, dirt detection light emitted from the light emitter for dirt detection penetrates the optical window and is received by the light receiver for distance measurement and the light receiver for dirt detection. Thus, dirt on the optical window is detected from light reception signal levels of the light receiver for distance measurement and the light receiver for dirt detection.

In contrast, as disclosed in, for example, JP 2015-136095 A, there is a target detecting device that detects a target according to an image obtained by imaging the area in front of a vehicle through a windshield of the vehicle. This target detecting device sequentially generates imaging frames including an imaging region image obtained by imaging a target with an imaging unit and an attached object observation image obtained by imaging an attached object on the windshield, and detects the attached object by using attached object observation images of imaging frames other than the imaging frame whose exposure amount is greatest from among the plurality of imaging frames.

In contrast, in order to improve detection accuracy of a target, for example, as disclosed in JP 2014-52274 A (Patent Document 6) and JP 2018-59846 A (Patent Document 7), there is a laser radar system in which laser radars are installed in the front part, the rear part, the right side, and the left side of a vehicle, and target detection regions of adjacent laser radars partially overlap with each other. In Patent Document 6, each laser radar emits a laser beam so that timings at which adjacent laser radars scan an overlapping region match. In Patent Document 7, each laser radar has a first direction with a long detectable distance and a second direction with a short detectable distance with respect to a target having identical reflectance. Among the adjacent laser radars, the first direction of one laser radar and the second direction of the other laser radar overlap with each other.

As conventionally, in a case where optical-system and electrical-system components for detecting dirt on an optical window are provided inside a target detecting device separately from optical-system and electrical-system components for target detection, cost is increased and it becomes necessary to provide a light projecting and receiving path for dirt detection separately from a light projecting and receiving path for target detection. Therefore, it becomes difficult to arrange each unit.

In addition, as conventionally, in a case of detecting dirt on an optical window by operating a light emitter, a light receiver, and the like in an operation pattern different from that at the time of target detection, it is not possible to detect a target at the time of dirt detection on the optical window. Therefore, there is a risk that a blind spot is generated where a target cannot be detected.

### SUMMARY

An object of the present invention is to detect dirt on an optical window of a target detecting device without adding a component dedicated to dirt detection or generating a blind spot where a target cannot be detected.

The target detecting device according to the present invention includes: a light emitter configured to emit light; a light receiver configured to receive light; an optical scanner configured to scan a predetermined range with light emitted from the light emitter, to perform scanning with light reflected by a target in the predetermined range and to guide the light to the light receiver; an object detector configured to detect one of existence of the target and a distance to the target according to a light reception state of the light receiver; a case configured to house the light emitter, the light receiver, and the optical scanner; an optical window formed of light-transmissive material that transmits light and configured to serve as one of a light projecting port and a light receiving port to an outside and an inside of the case; and a dirt detector configured to detect existence of dirt on the optical film according to a light reception state of the light receiver. An operation pattern of one of the light emitter and the light receiver differs between detection of the target by the object detector and detection of the dirt on the optical window by the dirt detector, and the detection of the target and the detection of the dirt are separately performed. The predetermined range scanned with light by the optical scanner partially overlaps with a range where another target detecting device detects the target. The detection of the dirt on the optical window by the dirt detector is performed in an overlapping region in the predetermined range, and the detection of the target by the object detector is performed in the other region.

In addition, a target detecting system according to the present invention includes a plurality of target detecting devices configured to detect one of existence of a target and a distance to the target in a predetermined range, and at least one of the plurality of target detecting devices is the target detecting device according to the present invention.

According to the target detecting device and the target detecting system of the present invention, the object detector detects a target and the dirt detector detects dirt on the optical window by using the light emitter and the light receiver in common. Therefore, it is not necessary to add a component dedicated to dirt detection to the target detecting device. In addition, the operation pattern of one of the light emitter and the light receiver differs between detection of the target by the object detector and detection of the dirt on the optical window by the dirt detector, and target detection and dirt detection are separately performed. However, the predetermined range scanned with light by the optical scanner partially overlaps with the target detection range of another target detecting device. Then, the dirt detector detects dirt on the optical window in the overlapping region, and the object detector detects the target in the other region in the predetermined range. Therefore, even if the object detector cannot detect a target when the dirt detector detects dirt on the optical window, another target detecting device detects the target in a region scanned with light at that time. Therefore, it is possible to detect dirt on the optical window of the target detecting device without causing a blind spot where a target cannot be detected in the predetermined range.

The target detecting device according to the present invention may cause the dirt detector to detect the dirt on the optical window in a partial region of the overlapping region in the predetermined range.

In addition, the partial region where the dirt on the optical window is detected may be a fixed region set in advance, or a variable region that varies by a predetermined angle at predetermined timing.

In addition, the light emitter of the target detecting device according to the present invention may include a plurality of light emitting elements. The light receiver may have a plurality of light receiving regions corresponding to the plurality of light emitting elements, respectively. The operation pattern of one of the light emitting element and the light receiving element may differ between detection of the target and detection of the dirt on the optical window.

Further, the plurality of target detecting devices included in the target detecting system according to the present invention is installed at a predetermined interval on a moving body. The predetermined range scanned with light by the optical scanner of one of the plurality of target detecting devices may partially overlap with the predetermined range scanned with light by the optical scanner of another of the plurality of target detecting devices, the one of the plurality of target detecting devices and the other of the plurality of target detecting devices being adjacent to each other. In the overlapping region in the predetermined range, the one of the plurality of target detecting devices may cause the dirt detector to detect the dirt on the optical window, and the other of the plurality of target detecting devices may cause the object detector to detect the target.

According to the present invention, it is possible to detect dirt on the optical window of the target detecting device without adding a component dedicated to dirt detection and generating a blind spot where a target cannot be detected.

### BRIEF DESCRIPTION OF THE DRAWINGS

FIG. 1 is a configuration diagram of a target detecting system according to an embodiment of the present invention.

FIG. 2 is a view illustrating installation states and scanning ranges of a target detecting device of FIG. 1.

FIG. 3 is an electrical configuration diagram of the target detecting device of FIG. 1.

FIG. 4 is a rear view of an optical system of the target detecting device of FIG. 1.

FIG. 5A is a view illustrating a light projecting path of an optical system of the target detecting device of FIG. 1.

FIG. 5B is a view illustrating a light receiving path of the optical system of the target detecting device of FIG. 1.

FIG. 6 is a side view of the optical system of the target detecting device of FIG. 1.

FIGS. 7A and 7B are views illustrating light projection and reception states of the optical system of the target detecting device of FIG. 1.

FIG. 8 is a view illustrating a light projection and reception states of the optical system of the target detecting device of FIG. 1.

FIGS. 9A and 9B are views illustrating an example of a light projection and reception states of the optical system in a case where dirt adheres to an optical window of the target detecting device of FIG. 1.

FIG. 10 is a view illustrating target detection regions and dirt detection regions of target detecting devices according to a first embodiment of the present invention.

FIG. 11 is a flowchart illustrating operation of the target detecting device according to the first embodiment of the present invention.

FIG. 12A is a view illustrating target detection regions and dirt detection regions of target detecting devices according to a second embodiment of the present invention.

FIG. 12B is a view illustrating target detection regions and dirt detection regions of the target detecting devices according to the second embodiment of the present invention.

FIGS. 13A to 13C are views illustrating target detection regions and dirt detection regions of target detecting devices according to a third embodiment of the present invention.

FIG. 14 is a flowchart illustrating operation of the target detecting device according to the third embodiment of the present invention.

### DETAILED DESCRIPTION

Hereinafter, embodiments of the present invention will be described with reference to the drawings. In the drawings, identical or corresponding parts are denoted by identical reference signs.

First, a configuration of a target detecting system 100 according to an embodiment will be described.

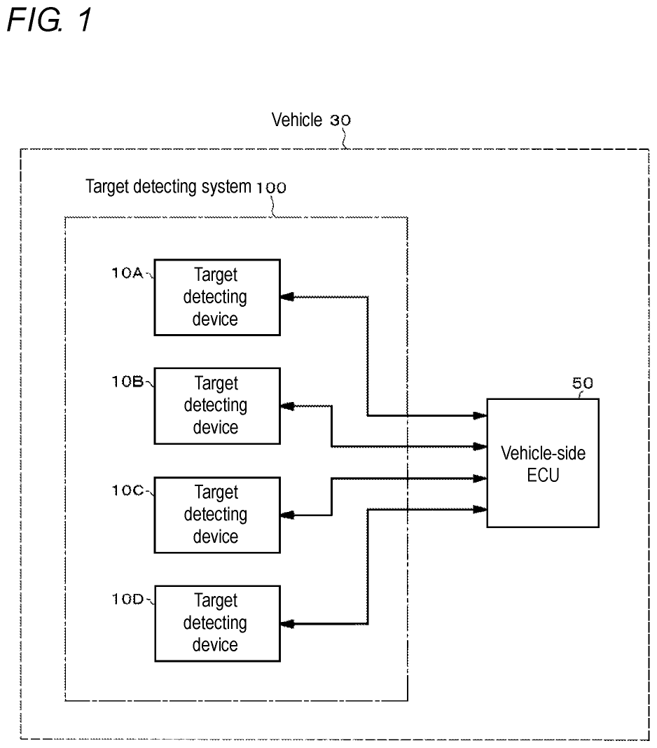

FIG. 1 is a configuration diagram of the target detecting system 100. The target detecting system 100 is mounted on a vehicle 30 configured of a four-wheeled vehicle together with a vehicle-side ECU 50 and the like. The target detecting system 100 includes a plurality of (four in this example) target detecting devices 10A, 10B, 10C, 10D. Each of the target detecting devices 10A to 10D is configured of a laser radar, and is electrically connected to the vehicle-side ECU 50.

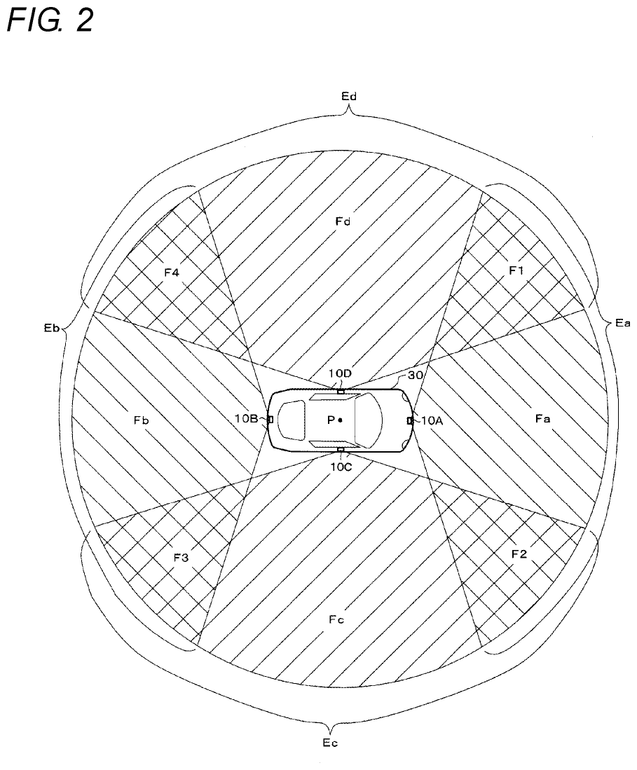

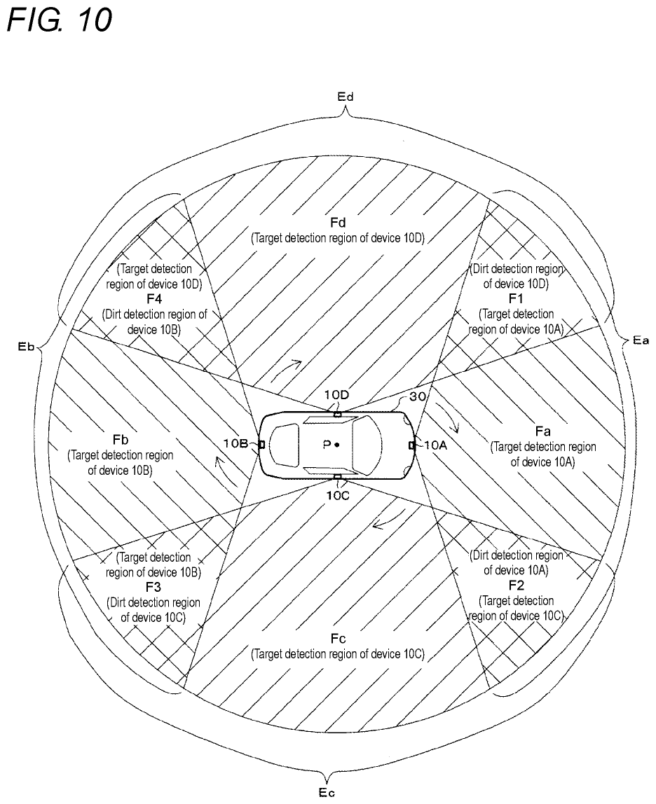

FIG. 2 is a view illustrating installation states, scanning ranges, and detection regions of the target detecting devices 10A, 10B, 10C, 10D. In FIG. 2, with respect to the vehicle 30, the right side is the front, the left side is the rear, the upper side is a left side, and the lower side is a right side (the same applies in FIGS. 10, 12A, 12B, 13). The target detecting devices 10A, 10B, 10C, 10D are installed at the front part, the rear part, the right side, and the left side of the vehicle 30, respectively, and detect existence of a target (person, an object, or the like) in predetermined ranges Ea, Eb, Ec, Ed in front of, behind, on the right side, and on the left side of the vehicle 30, respectively, and the distance or the like to the target.

In addition, the target detecting devices 10A to 10D output detection results of a target, a distance, and the like to the vehicle-side ECU 50 illustrated in FIG. 1. The vehicle-side ECU 50 controls operation of on-vehicle equipment (not illustrated) according to the detection results of the target detecting devices 10A to 10D.

Next, the electrical configuration of the target detecting devices 10A to 10D will be described. Note that the electrical configurations of the target detecting devices 10A to 10D are identical.

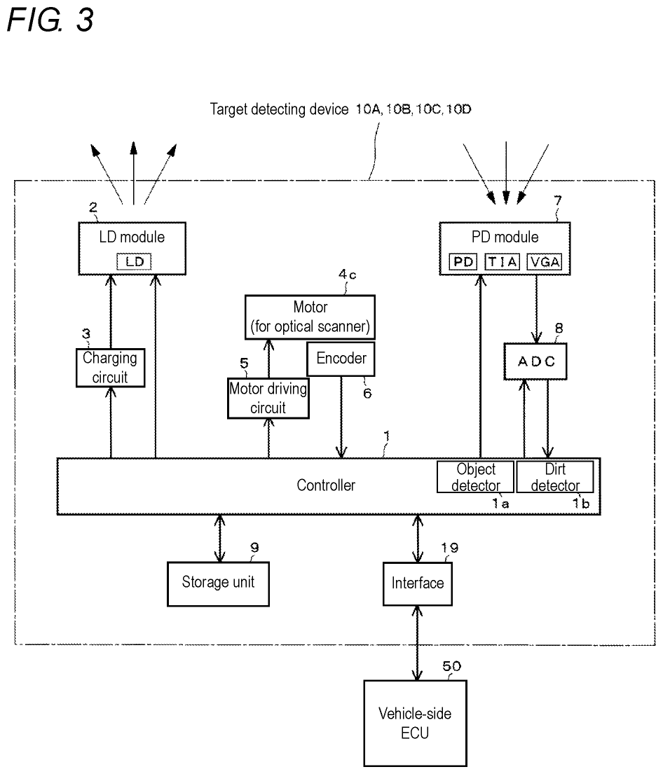

FIG. 3 is an electrical configuration diagram of each of the target detecting devices 10A to 10D. A controller 1 is configured of a CPU and the like, and controls operation of each unit. The controller 1 includes an object detector 1a and a dirt detector 1b. The function of each of the object detector 1a and the dirt detector 1b is realized by a software program executed by the CPU of the controller 1.

An LD module 2 is packaged. Although the LD module 2 includes a plurality of LDs (laser diodes) which are light sources, only one LD block is illustrated in FIG. 3 for the sake of convenience. Each LD is a light emitting element that emits a high-output light pulse. The LD module 2 is an example of the “light emitter” in the present invention.

The controller 1 controls operation of each LD of the LD module 2. Specifically, for example, the controller 1 causes each LD to emit light so as to project light to a target such as a person or an object. In addition, the controller 1 stops light emission of each LD and charges each LD by using a charging circuit 3.

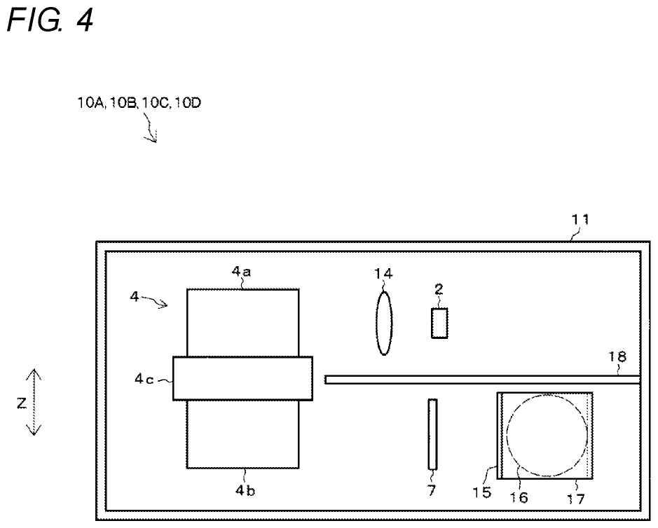

A motor 4c is a drive source of an optical scanner 4 (such as FIG. 4) described later. A motor driving circuit 5 drives the motor 4c. An encoder 6 detects the rotation state (angle, rotational speed, and the like) of the motor 4c. The controller 1 causes the motor driving circuit 5 to rotate the motor 4c so as to control operation of the optical scanner 4. In addition, the controller 1 detects the operation state (the operation amount, the operation position, and the like) of the optical scanner 4 according to output of the encoder 6.

A PD module 7 is packaged. The PD module 7 includes a PD (photodiode) which is a light receiving element, a TIA (transimpedance amplifier), a VGA (variable gain amplifier) and the like (detailed circuits are not illustrated). The PD module 7 is an example of the “light receiver” in the present invention.

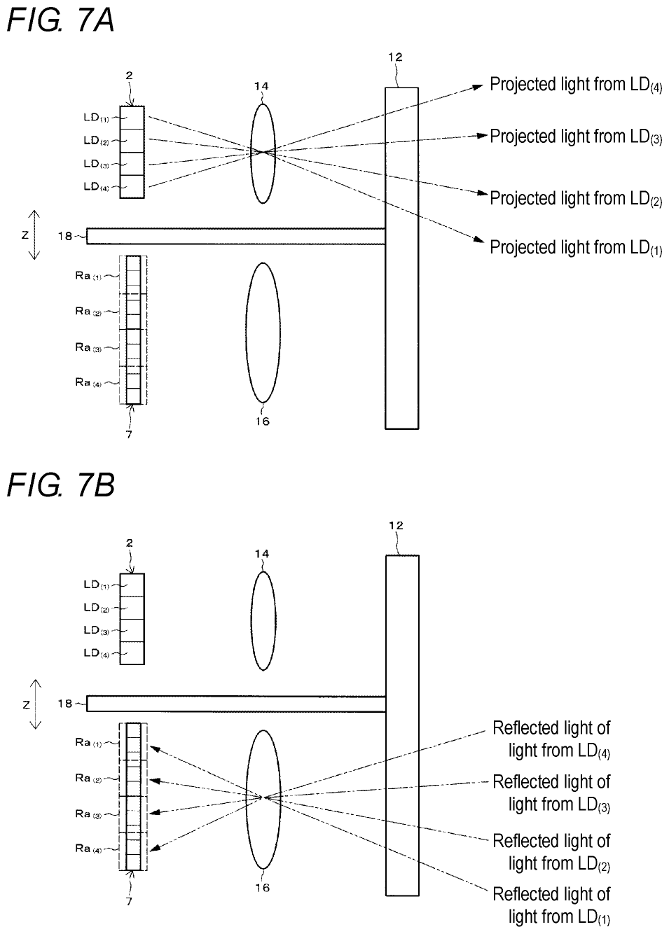

The PD has a plurality of light receiving regions (Ra₍₁₎ to Ra₍₄₎ in FIG. 7 and the like described later) so as to correspond to the respective LDs of the LD module 2. A plurality of the TIAs is provided in the PD module 7 so as to correspond to the respective light receiving regions of the PD. A plurality of the VGAs is provided in the PD module 7 so as to correspond to the respective TIAs. The respective TIAs cause output signals from the respective light receiving regions of the PD to be input to the respective VGAs. The respective VGAs amplify the output signals from the respective TIAs and cause the output signals to be input to ADCs (analog-digital converters) 8. Although the plurality of ADCs 8 is provided correspondingly to the respective light receiving regions of the PD, only one block of the ADC 8 is illustrated in FIG. 3 for the sake of convenience. Each ADC 8 converts an analog signal output from each light receiving region of the PD via the corresponding TIA and VGA into a digital signal.

The controller 1 controls operation of each unit of the PD module 7. Specifically, for example, the controller 1 causes the LD of the LD module 2 to emit light and causes the PD of the PD module 7 to receive light reflected by a target. Then, the controller 1 causes the TIA and the VGA to process a light reception signal that is output from the PD according to the light reception state of the PD. Further, the controller 1 causes the ADC 8 to convert an analog light reception signal output from the PD module 7 into a digital light reception signal.

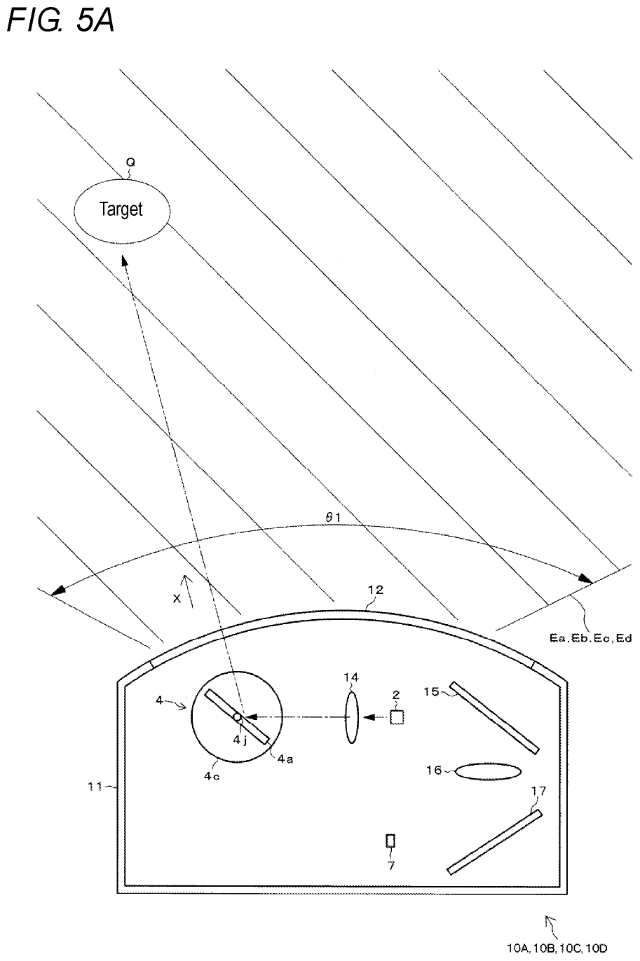

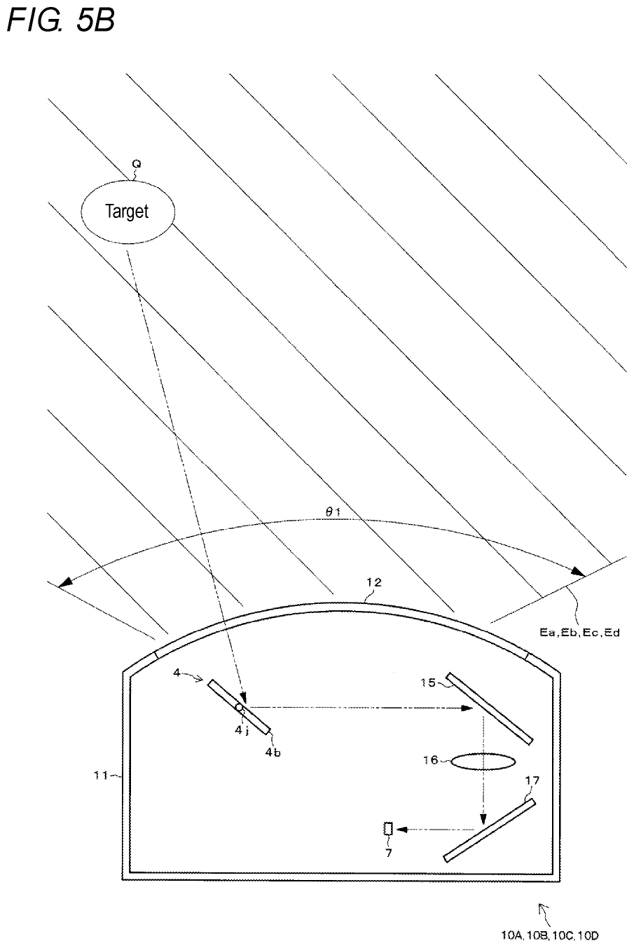

Then, according to the digital light reception signal which has been converted by the ADC 8, the controller 1 determines the light reception state of the PD, and the object detector 1a detects existence of a target according to the determination result. In addition, in a case where the object detector 1a detects that there is a target, the object detector 1a calculates the time from when the LD emits light to when the PD receives the reflected light from the target, and detects the distance to the target according to the time. The dirt detector 1b detects existence of dirt on an optical window 12 (FIG. 5A and the like) described later, according to the light reception state of the PD.

The storage unit 9 is configured of a volatile or a nonvolatile memory. The storage unit 9 stores information for the controller 1 to control each unit of the target detecting devices 10A to 10D, information for detecting a target, and the like. In addition, in the storage unit 9, the controller 1 stores the detection result obtained when the dirt detector 1b detects that there is dirt on the optical window 12.

An interface 19 is configured of a communication circuit for communicating with the vehicle-side ECU 50. The controller 1 transmits and receives various control information to and from the vehicle-side ECU 50 via the interface 19 and transmits detection results of the object detector 1a and the dirt detector 1b to the vehicle-side ECU 50 via the interface 19.

The vehicle-side ECU 50 controls operation of on-vehicle equipment (not illustrated) of a traveling operation system mounted on the vehicle 30 according to the detection results of a target transmitted from the target detecting devices 10A to 10D and performs travelling control and stop control of the vehicle 30. In addition, according to the detection result of dirt on the optical window 12 transmitted from the target detecting devices 10A to 10D, the vehicle-side ECU 50 displays the dirty state of the optical window 12 on a display (not illustrated) installed in a vehicle compartment of the vehicle 30 or operates a cleaning device mounted on the vehicle 30 to remove the dirt on the optical window 12.

Next, the optical configuration and light projecting and receiving paths of the target detecting devices 10A to 10D will be described. Note that the optical configurations and the light projecting and receiving paths of the target detecting devices 10A to 10D are identical.

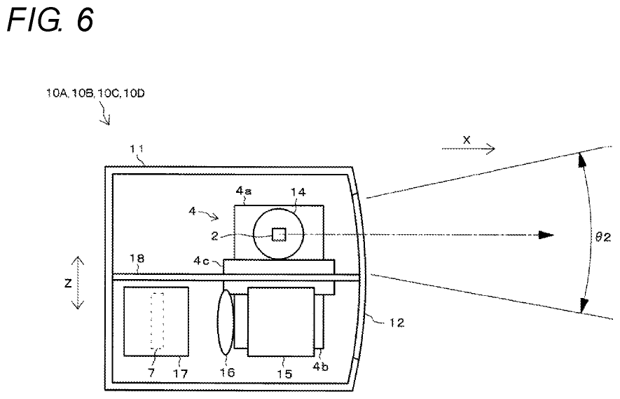

FIG. 4 is a rear view of the optical system of each of the target detecting devices 10A to 10D. FIG. 5A is a view illustrating the light projecting path of the optical system of each of the target detecting devices 10A to 10D. FIG. 5B is a view illustrating a light receiving path of the optical system of each of the target detecting devices 10A to 10D. FIG. 6 is a side view of the optical system of each of the target detecting devices 10A to 10D.

FIGS. 5A and 5B illustrate the inside and the area in front of each of the target detecting devices 10A to 10D viewed from above. FIG. 4 illustrates the inside of each of the target detecting devices 10A to 10D viewed from the rear (the lower side in FIG. 5A). FIG. 6 illustrates the inside of each of the target detecting devices 10A to 10D viewed from a side (the right side in FIG. 4).

In the target detecting devices 10A to 10D, the case 11 is formed in a box shape by a synthetic resin which does not transmit light. The optical window 12 is provided on a front surface of the case 11 as illustrated in FIGS. 5A to 6. The optical window 12 is formed in a dome shape and made of light-transmissive material such as synthetic resin or glass which transmits light. The optical window 12 is a light projecting and receiving port for light to the outside and inside of the case 11.

The target detecting devices 10A to 10D are installed at the front part, the rear part, the right side, and the left side of the vehicle 30 so that the optical window 12 is directed to the area in the front, behind, to the right, and to the left of the vehicle 30, and the short-side direction of the case 11 is parallel to the vertical direction (top-bottom direction) Z (FIG. 2).

As illustrated in FIGS. 4 to 6, in the case 11, optical-system components such as the LD module 2, a transmitter lens 14, the optical scanner 4, a reflecting mirror 15, a receiver lens 16, a reflecting mirror 17, and the PD module 7 are housed. Among them, the LD module 2, the motor 4c of the optical scanner 4, and the PD module 7 are electronic components that are electrically driven. Other electronic components illustrated in FIG. 1 are also housed in the case 11. Note that FIG. 5B does not illustrate the LD module 2, the transmitter lens 14, and a light projecting mirror 4a and the motor 4c of the optical scanner 4 described later.

The LDs of the LD module 2, the transmitter lens 14, and the optical scanner 4 constitute a light projecting optical system. In addition, the optical scanner 4, the reflecting mirror 15, the reflecting mirror 17, the receiver lens 16, and the PDs of the PD module 7 constitute a light receiving optical system. A light shielding plate 18 is provided between the light projecting optical system and the light receiving optical system as illustrated in FIGS. 4 and 6 in order to prevent light interference. In FIGS. 5A and 5B, the light shielding plate 18 is not illustrated. The LD module 2, the transmitter lens 14, the motor 4c of the optical scanner 4, the reflecting mirror 15, the receiver lens 16, the reflecting mirror 17, the PD module 7, and the light shielding plate 18 are fixed in the case 11.

As illustrated in FIG. 4, the LD module 2 is disposed at the upper central part of each of the target detecting devices 10A to 10D. The transmitter lens 14 is disposed on the light emitting side (left side in FIGS. 4, 5A, and 5B) of each LD included in the LD module 2. The optical scanner 4 is disposed on the side opposite to the LD module 2 with respect to the transmitter lens 14.

The optical scanner 4 is also referred to as a light deflector, and includes the light projecting mirror 4a, a light receiving mirror 4b, the motor 4c, and the like. The motor 4c is configured of a brushless motor. The light projecting mirror 4a is connected to an upper end part of a rotary shaft 4j (FIGS. 5A and 5B) of the motor 4c. The light receiving mirror 4b is connected to the lower end part of the rotary shaft 4j of the motor 4c. The light projecting and receiving mirrors 4a, 4b are formed of double-sided mirrors formed in plate shapes. That is, both plate surfaces of the light projecting and receiving mirrors 4a, 4b are reflecting surfaces. The light projecting and receiving mirrors 4a, 4b rotate in conjunction with the rotary shaft 4j of the motor 4c. The rotary shaft 4j of the motor 4c is parallel to the vertical direction Z.

The PD module 7 is disposed at the lower central part of each of the target detecting devices 10A to 10D. The reflecting mirror 15, the receiver lens 16, and the reflecting mirror 17 are disposed on the side opposite to the optical scanner 4 with respect to the PD module 7. The PD module 7, the reflecting mirror 15, the receiver lens 16, and the reflecting mirror 17 are disposed below the LD module 2.

On the light-receiving side (right side in FIGS. 4, 5A, and FIG. 5B) of each PD included in the PD module 7, the reflecting mirror 17 is disposed so as to be inclined at a predetermined angle. In front of the reflecting mirror 17 (on an optical window 12 side), the reflecting mirror 15 is disposed so as to be inclined at a predetermined angle. The receiver lens 16 is disposed between the reflecting mirror 17 and the reflecting mirror 15.

In FIG. 5A, arrows of one-dot chain lines illustrate the light projecting path of the above-described optical system. In FIG. 5A, first, the LD of the LD module 2 emits light. Then, the transmitter lens 14 adjusts a spread and the like of the light, and the light strikes the light projecting mirror 4a of the optical scanner 4. At this time, the motor 4c rotates to change the angle (orientation) of the light projecting mirror 4a, and one of the reflecting surfaces of the light projecting mirror 4a is directed to a predetermined range Ea to Ed side. Therefore, after the light from the LD has penetrated the transmitter lens 14, the light is reflected by the light projecting mirror 4a and penetrates almost the upper half of the optical window 12, and the predetermined range Ea to Ed located outside is scanned with the light. Also in FIG. 6, an arrow of a one-dot chain line illustrates light that the target detecting devices 10A to 10D projects to the predetermined ranges Ea to Ed.

In a case where a target Q exists in the predetermined range Ea to Ed, light that the target detecting device 10A to 10D projects to the predetermined range Ea to Ed is reflected by the target Q. In FIG. 5B, arrows of two-dot chain lines illustrate the light receiving path of the optical system in a case where the target detecting device 10A to 10D receives reflected light from the target Q.

In FIG. 5B, reflected light from the target Q of light projected from each of the target detecting devices 10A to 10D penetrates the optical window 12 and strikes the light receiving mirror 4b of the optical scanner 4. At this time, the motor 4c rotates to change the angle (orientation) of the reflecting surface of the light receiving mirror 4b, and one of the reflecting surfaces of the light receiving mirror 4b is directed to the predetermined range Ea to Ed side. Therefore, reflected light which has been reflected by the target Q and has penetrated almost the lower half of the optical window 12 is reflected by the light receiving mirror 4b and is guided to the reflecting mirror 15. That is, the optical scanner 4 deflects reflected light from the target Q that exists in the predetermined range Ea to Ed to a reflecting mirror 15 side. Then, the reflected light guided to the reflecting mirror 15 by the optical scanner 4 is reflected by the reflecting mirror 15, enters the receiver lens 16, and is condensed and adjusted by the receiver lens 16, and then is further reflected by the reflecting mirror 17 and is received by the PD of the PD module 7.

The PD module 7 and the ADC 8 process the light reception signal output from the PD according to the light reception state of the above reflected light. Then, the object detector 1a of the controller 1 detects existence of the target Q and calculates the distance to the target Q according to the processed light reception signal. At this time, according to the rotation angle of the motor 4c of the optical scanner 4, the object detector 1a detects the orientation in which the target Q exists in the horizontal direction. In addition, the object detector 1a detects the orientation in which the target Q exists in the vertical direction according to an output signal from each light receiving region of the PD.

The predetermined ranges Ea to Ed hatched in FIGS. 2, 5A, and 5B are ranges (top view) which the target detecting devices 10A to 10D scan with light to and from which the target detecting devices 10A to 10D project and receive light. (FIGS. 5A and 5B illustrate the vicinity of the target detecting device 10A to 10D in the predetermined range Ea to Ed.) The rotary shaft 4j of the motor 4c of the optical scanner 4 is parallel to the vertical direction Z. Therefore, the optical scanner 4 horizontally scans the predetermined range Ea to Ed with light. As illustrated in FIGS. 5A and 5B, an optical scanning angle θ1 by the optical scanner 4 in the horizontal direction is an obtuse angle (90°<θ1<180°).

As illustrated in FIG. 6, light projected from the target detecting device 10A to 10D to the predetermined range Ea to Ed spreads and is emitted in the traveling direction X at a predetermined angle θ2 in the vertical direction Z. The angle θ2 of the light emission range in the vertical direction Z is smaller than the scanning angle θ1 in the horizontal direction illustrated in FIG. 5A and the like, and is an acute angle (0°<θ2<90°).

As illustrated in FIG. 2, the target detecting devices 10A to 10D are installed at the front part, the rear part, the right side, and the left side of the vehicle 30 so as to face the area in the front, behind, to the right, and to the left of the vehicle 30. Therefore, the predetermined ranges Ea to Ed that the target detecting devices 10A to 10D cause the optical scanner 4 to horizontally scan with light spread in a sector shape in front of, behind, to the right, and to the left of the vehicle 30, respectively.

The predetermined ranges (that is, light projecting and receiving ranges) Ea to Ed that the adjacent target detecting devices 10A to 10D scan with light are set so as to partially overlap with each other. For example, partial regions F2 overlap with each other in the predetermined ranges Ea, Ec scanned with light by the target detecting device 10A and the target detecting device 10C adjacent to each other in the clockwise direction with the center P of the vehicle 30 illustrated in FIG. 2 as the rotation center. In addition, partial regions F3 overlap with each other in the predetermined ranges Ec, Eb scanned with light by the target detecting device 10C and the target detecting device 10B adjacent to each other. In addition, partial regions F4 overlap with each other in the predetermined ranges Eb, Ed scanned with light by the target detecting device 10B and the target detecting device 10D adjacent to each other. Further, partial regions F1 overlap with each other in the predetermined ranges Ed, Ea scanned with light by the target detecting device 10D and the target detecting device 10A adjacent to each other.

That is, the predetermined ranges Ea to Ed that the target detecting devices 10A to 10D scan with light are configured of the regions F1 to F4 overlapping with the predetermined ranges Ea to Ed that the adjacent target detecting devices 10A to 10D scan with light, and regions Fa to Fd not overlapping with the predetermined ranges Ea to Ed that the adjacent target detecting devices 10A to 10D scan with light.

Optical scanning range Ea of target detecting device 10A=overlapping region F1+non-overlapping region Fa+overlapping region F2
Optical scanning range Eb of target detecting device 10B=overlapping region F3+non-overlapping region Fb+overlapping region F4
Optical scanning range Ec of target detecting device 100=overlapping region F2+non-overlapping region Fc+overlapping region F3
Optical scanning range Ed of target detecting device 10D=overlapping region F4+non-overlapping region Fd+overlapping region F1

In the predetermined ranges Ea to Ed that the target detecting devices 10A to 10D scan with light, the overlapping regions F1, F2, F3, F4 are set to an identical size. In addition, the scanning angle of each of the overlapping regions F1, F2, F3, F4 is set to be smaller than that of the non-overlapping regions Fa, Fb, Fc, Fd.

Next, light projection and reception principles of the target detecting devices 10A to 10D will be described. Note that the light projecting and receiving principles of the target detecting devices 10A to 10D are identical.

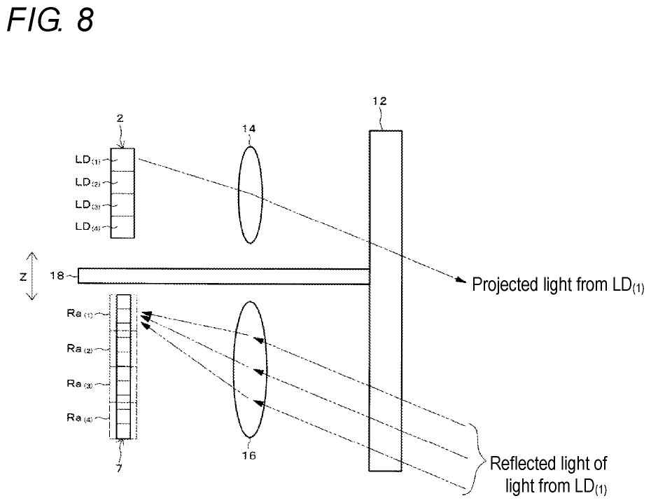

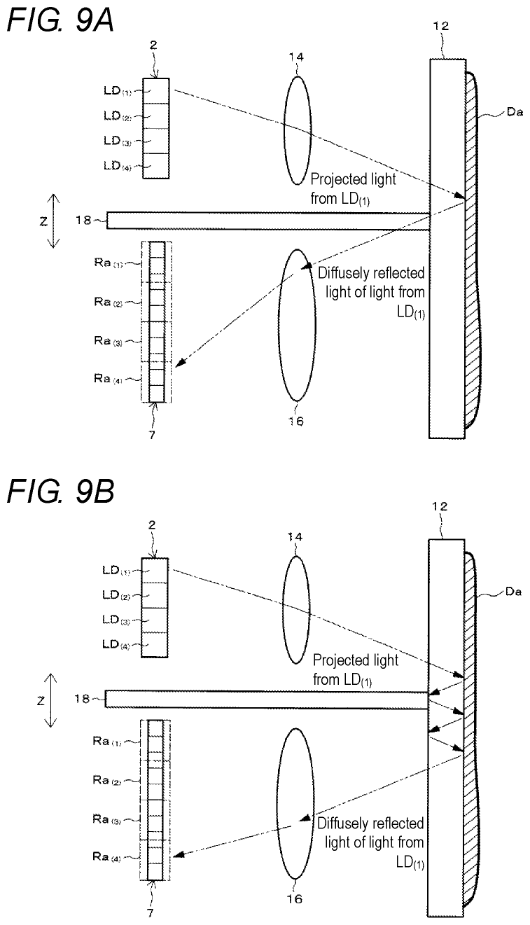

FIGS. 7A and 7B are views illustrating light projection and reception states of the optical system of each of the target detecting devices 10A to 10D. FIG. 8 is a view illustrating an example of the light projection and reception states of the optical system of each of the target detecting devices 10A to 10D. FIGS. 9A and 9B are views illustrating an example of a light projection and reception states of the optical system in a case where dirt Da adheres to the optical window 12 of each of the target detecting device 10A to 10D. Each drawings schematically illustrates the optical system of each of the target detecting devices 10A to 10D, and the optical scanner 4 and the reflecting mirrors 15, 17 are not illustrated.

As illustrated in FIGS. 7A, 7B, and the like, in the LD module 2, four LD₍₁₎ to LD₍₄₎ are provided so as to be aligned in the vertical direction Z. The LD₍₁₎ to LD₍₄₎ emit light in predetermined orientations in the vertical direction Z, as indicated by an arrow of a one-dot chain line in FIG. 7A. Specifically, the LD₍₁₎ located at the uppermost position emits light downward at a predetermined angle with respect to the horizontal plane (parallel to the light shielding plate 18). The LD₍₂₎ immediately below the LD₍₁₎ emits light downward at a predetermined angle smaller than that of the LD₍₁₎ with respect to the horizontal plane. The LD₍₃₎ immediately below the LD₍₂₎ emits light upward at a predetermined angle with respect to the horizontal plane. The LD₍₄₎ located at the lowermost position emits light upward at a predetermined angle greater than that of the LD₍₃₎ with respect to the horizontal plane.

The transmitter lens 14 and the optical scanner 4 cause light emitted from each of the LD₍₁₎ to LD₍₄₎ to penetrate a predetermined location on the substantially upper half of the optical window 12 and to be emitted in a predetermined orientation. Therefore, as illustrated in FIG. 6, light is projected over the range of the predetermined angle θ2 in the vertical direction Z, in front of each of the target detecting devices 10A to 10D.

For example, as illustrated in FIG. 7B, the PD of the PD module 7 is configured of a photodiode array in which a plurality of light receiving regions Ra₍₁₎ to Ra₍₄₎ is one-dimensionally arranged in one package. The light receiving regions Ra₍₁₎ to Ra₍₄₎ are arranged in the vertical direction Z in this order from the top. A plurality of light receiving surfaces is provided in each of the light receiving regions Ra₍₁₎ to Ra₍₄₎. The light receiving regions Ra₍₁₎ to Ra₍₄₎ correspond to the LD₍₁₎ to LD₍₄₎, respectively.

As described above, light emitted from each of the LD₍₁₎ to LD₍₄₎ and projected to the predetermined range Ea to Ed (FIG. 5A and the like) is reflected by the target Q existing in the predetermined range Ea to Ed.

For example, when each of the target detecting devices 10A to 10D is viewed from the front or the rear (FIG. 4), the size in the longitudinal direction (lateral width) of each of the target detecting devices 10A to 10D is 150 mm or less, and the size in the lateral direction (height) is 100 mm or less. In contrast, a person or an object (a vehicle ahead, a road surface, or the like) which is the target Q is several times or greater.

Therefore, for example, as illustrated in FIG. 8, reflected light (arrows of two-dot chain lines) from the target Q of light projected from the LD₍₁₎ enters the lower half of the optical window 12, in parallel to the light projection direction (arrow of one-dot chain line). Then, the reflected light penetrates the optical window 12, passes through the optical scanner 4 (FIG. 5B), is guided to the light receiving region Ra₍₁₎ of the PD of the PD module 7 by the receiver lens 16 and the reflecting mirrors 15, 17 (FIG. 5B), and is received by the light receiving region Ra₍₁₎.

Similarly, reflected light (arrows of two-dot chain lines in FIG. 7B) from the target Q of light emitted by the other LD₍₂₎ to LD₍₄₎ also enters the lower half of the optical window 12, in parallel to the light projection directions (arrows of one-dot chain lines in FIG. 7A). Then, in the reflected light, the reflected light of the light from the LD₍₂₎ penetrates the optical window 12, passes through the optical scanner 4, is guided to the light receiving region Ra₍₂₎ of the PD of the PD module 7 by the receiver lens 16 and the like, and is received by the light receiving region Ra₍₂₎. The reflected light of the light from the LD₍₃₎ penetrates the optical window 12, passes through the optical scanner 4, is guided to the light receiving region Ra₍₃₎ of the PD of the PD module 7 by the receiver lens 16 and the like, and is received by the light receiving region Ra₍₃₎. The reflected light of the light from the LD₍₄₎ penetrates the optical window 12, passes through the optical scanner 4, is guided to the light receiving region Ra₍₄₎ of the PD of the PD module 7 by the receiver lens 16 and the like, and is received by the light receiving region Ra₍₄₎.

That is, in the reflected light from the target Q of the light emitted from the LD₍₁₎ to LD₍₄₎, the reflected light passed through the optical window 12 and the optical scanner 4 is guided by the receiver lens 16 and the like to the light receiving regions Ra₍₁₎ to Ra₍₄₎ of the PD corresponding to the LD₍₁₎ to LD₍₄₎, respectively. In addition, as indicated by the arrows of two-dot chain lines in FIG. 7B, the light receiving regions Ra₍₁₎ to Ra₍₄₎ of the PD separately receive reflected light from target Q of the light emitted from the LD₍₁₎ to LD₍₄₎, respectively. Then, the PD outputs a light reception signal according to the light reception states of the light receiving regions Ra₍₁₎ to Ra₍₄₎, and the object detector 1a detects the orientation in which the target Q exists in the vertical direction Z according to the light reception signal.

In contrast, as illustrated in FIGS. 9A and 9B, in a case where dirt Da such as mud adheres to the surface of the optical window 12, for example, light emitted from the LD₍₁₎ (arrows of one-dot chain lines) is guided by the transmitter lens 14 and the like and penetrates the optical window 12; however, the light cannot penetrate the dirt Da and is diffusely reflected by the dirt Da. Then, for example, as indicated by arrows of two-dot chain lines in FIG. 9A, the light diffusely reflected by the dirt Da is emitted from the optical window 12 in a direction not parallel to the light projection direction (arrow of one-dot chain line) from the LD₍₁₎ to the optical window 12, passes through the optical scanner 4, the receiver lens 16 and the like, and is then received by the light receiving region Ra₍₄₎ of the PD not corresponding to the LD₍₁₎. Depending on the characteristics of the dirt Da, the other light receiving region Ra₍₂₎ or Ra₍₃₎ of the PD not corresponding to the LD₍₁₎ may receive diffusely reflected light due to the dirt Da.

In addition, depending on the characteristics of the dirt Da and the optical window 12, for example, as illustrated in FIG. 9B, light diffusely reflected by the dirt Da may be reflected a plurality of times inside the optical window 12. In this case, for example, the diffusely reflected light is emitted from the optical window 12 in a direction not parallel to the light projection direction (arrow of one-dot chain line) from the LD₍₁₎ to the optical window 12, passes through the optical scanner 4, the receiver lens 16 and the like, and is then received by the light receiving region Ra₍₄₎ of the PD not corresponding to the LD₍₁₎. The diffusely reflected light may be received by the other light receiving regions Ra₍₂₎, Ra₍₃₎ of the PD not corresponding to the LD₍₁₎.

Similarly, light emitted from the other LD₍₂₎ to LD₍₄₎ is also guided by the transmitter lens 14 and penetrates the optical window 12; however, the light cannot penetrate the dirt Da, and is diffusely reflected by the dirt Da. Then, the diffusely reflected light is emitted from the optical window 12 in directions not parallel to the light projection directions from the LD₍₂₎ to LD₍₄₎ to the optical window 12, passes through the optical scanner 4, the receiver lens 16, and the like, and is then received by the light receiving region Ra₍₁₎ to Ra₍₄₎ of the PD not corresponding to the LD₍₂₎ to the LD₍₄₎.

Therefore, when light is emitted from a specific LD corresponding to a specific orientation among the plurality of LD₍₁₎ to LD₍₄₎, if one of the light receiving regions Ra₍₁₎ to Ra₍₄₎ of the PD not corresponding to the specific LD receives the light, the dirt detector 1b (FIG. 1) detects that there is dirt Da on the optical window 12.

In each of the target detecting devices 10A to 10D, while the motor 4c of the optical scanner 4 is driven to rotate the mirrors 4a, 4b at predetermined rotational speed, the LD₍₁₎ to LD₍₄₎ sequentially emit light so as to detect light reception states of the light receiving regions Ra₍₁₎ to Ra₍₄₎ of the PD. Thus, the object detector 1a detects the target Q, and the dirt detector 1b detects the dirt Da on the optical window 12.

At that time, according to the light projecting and receiving principles described above, when the object detector 1a detects the target Q, while the optical scanner 4 performs scanning with light emitted from an LD, the light reception state of one of the light receiving region Ra₍₁₎ to Ra₍₄₎ of the PD corresponding to the LD is detected. In addition, when the dirt detector 1b detects the dirt Da of the optical window 12, while the optical scanner 4 performs scanning with light emitted from an LD, the light reception states of the light receiving regions Ra₍₁₎ to Ra₍₄₎ of the PD not corresponding to the LD are detected.

That is, in the target detecting devices 10A to 10D, the operation pattern of the PD of the PD module 7 differs between when the object detector 1a detects the target Q and when the dirt detector 1b detects the dirt Da. Therefore, since detection of the target Q by the object detector 1a and detection of the dirt Da by the dirt detector 1b cannot be performed simultaneously, detection of the target Q and detection of the dirt Da are separately performed.

The operation pattern of each LD of the LD module 2 may be different or identical between when the object detector 1a detects the target Q and when the dirt detector 1b detects the dirt Da. For example, when the object detector 1a detects the target Q, the LD₍₁₎ to LD₍₄₎ may emit light in predetermined order or a predetermined number of times, and when the dirt detector 1b detects dirt Da, the LD₍₁₎ to LD₍₄₎ may emit light in other order or another number of times, or a specific LD may emit light continuously.

Next, detection regions of a target Q and dirt Da of target detecting devices 10A to 10D of a first embodiment will be described.

FIG. 10 is a view illustrating target detection regions and dirt detection regions of the target detecting devices 10A to 10D according to the first embodiment. The target detecting devices 10A to 10D cause optical scanners 4 to scan predetermined ranges Ea to Ed with light in the clockwise direction with the center P of a vehicle 30 as the rotation center. The target detecting device 10A causes a dirt detector 1b to detect dirt Da on an optical window 12 in an overlapping region F2 near a scanning end in the predetermined range Ea, and causes an object detector 1a to detect a target Q in the other regions (overlapping region F1+non-overlapping region Fa).

Similarly, the target detecting device 10B causes a dirt detector 1b to detect dirt Da on an optical window 12 in an overlapping region F4 near a scanning end in the predetermined range Eb, and causes an object detector 1a to detect a target Q in the other regions (overlapping region F3+non-overlapping region Fb). The target detecting device 10C causes a dirt detector 1b to detect dirt Da on an optical window 12 in an overlapping region F3 near a scanning end in the predetermined range Ec, and causes an object detector 1a to detect a target Q in the other regions (overlapping region F2+non-overlapping region Fc). The target detecting device 10D causes a dirt detector 1b to detect dirt Da on an optical window 12 in an overlapping region F1 near a scanning end in the predetermined range Ed, and causes an object detector 1a to detect a target Q in the other regions (overlapping region F4+non-overlapping region Fd).

That is, regarding each of the target detecting devices 10A and 10C, the target detecting devices 100 and 10B, the target detecting devices 10B and 10D, and the target detecting devices 10D and 10A among the target detecting devices 10A to 10D, the region (for example, F2) where one target detecting device (for example, 10A) detects the dirt Da of the optical window 12 is also the region (for example, F2) where the other target detecting device (for example, 10C) detects the target Q. In the controllers 1 (FIG. 3) of the target detecting devices 10A to 10D, the predetermined ranges Ea to Ed, the overlapping regions F1 to F4 (the target detection regions and the dirt detection regions), and the non-overlapping regions Fa to Fd (target detecting regions) regarding the respective target detection devices are set in advance.

Next, operation of the target detecting devices 10A to 10D according to the first embodiment will be described.

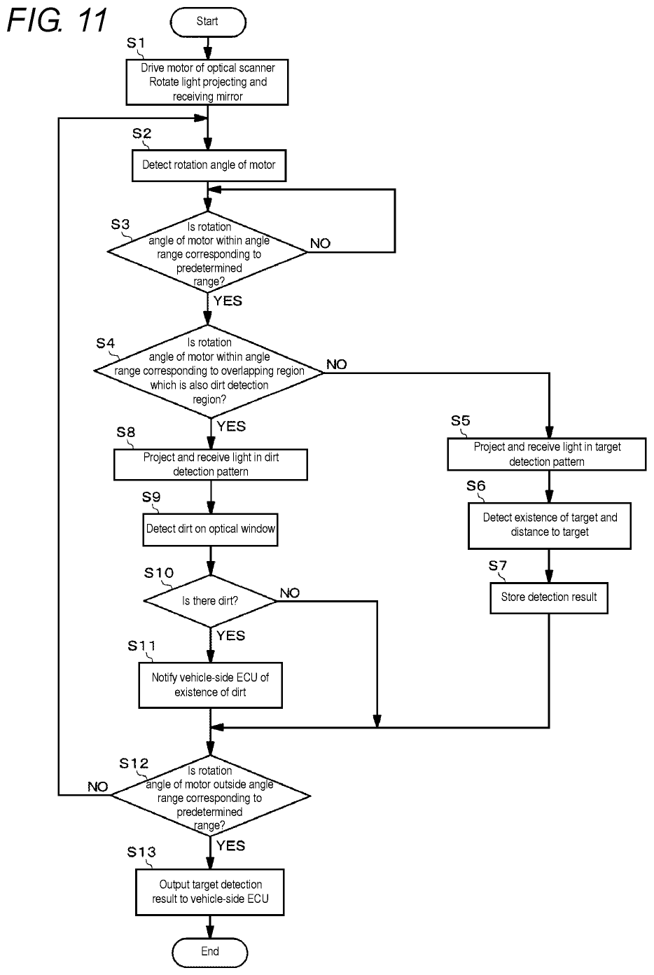

FIG. 11 is a flowchart illustrating operation of the target detecting devices 10A to 10D according to the first embodiment. Each step in FIG. 11 is executed by the controller 1 provided in each of the target detecting devices 10A to 10D. First, the controller 1 drives a motor 4c of an optical scanner 4 at predetermined rotational speed (step S1) to rotate light projecting and receiving mirrors 4a, 4b in a predetermined direction. In addition, the controller 1 detects the rotation angle of the motor 4c according to output of an encoder 6 (step S2).

Then, the controller 1 checks whether or not the rotation angle of the motor 4c is within an angle range corresponding to the predetermined range Ea to Ed (FIG. 10 and the like) (step S3). Here, if the rotation angle of the motor 4c is within the angle range corresponding to the predetermined range Ea to Ed set in advance (step S3: YES), the controller 1 further checks whether or not the rotation angle of the motor 4c is within the angle range corresponding to the overlapping region F1 to F4 set in advance which is also the dirt detection region (step S4).

If the rotation angle of the motor 4c is not within the angle range corresponding to the overlapping region F1 to F4 which is also the dirt detection region in the predetermined range Ea to Ed (step S4: NO), the controller 1 causes an LD module 2 and a PD module 7 to operate in a target detection pattern, and causes the optical scanner 4 to project and receive light to and from the predetermined range Ea to Ed (step S5). Then, the controller 1 causes the object detector 1a to detect existence of the target Q and the distance to the target Q according to the light reception state of the PD module 7 (step S6), and stores the detection results in a storage unit 9 (step S7).

Then, the controller 1 checks whether or not the rotation angle of the motor 4c is outside the angle range corresponding to the predetermined range Ea to Ed (step S12). Here, if the rotation angle of the motor 4c is not outside the angle range corresponding to the predetermined range Ea to Ed (step S12: NO), optical scanning (light projection and reception) of the predetermined range Ea to Ed is not completed. Therefore, the controller 1 returns to step S2 and repeats the above-described processes.

If the rotation angle of the motor 4c is within the angle range corresponding to the overlapping region F1 to F4 which is also the dirt detection region in the predetermined range Ea to Ed (step S3: YES, step S4: YES), the controller 1 causes the LD module 2 and the PD module 7 to operate in a dirt detection pattern, and causes the optical scanner 4 to project and receive light to and from the dirt detection region (step S8). Then, the controller 1 causes the dirt detector 1b to detect existence of the dirt Da on the optical window 12 according to the light reception state of the PD module 7 (step S9). Here, if the controller 1 detects that there is the dirt Da on the optical window 12 (step S10: YES), the controller 1 notifies a vehicle-side ECU 50 of this fact via an interface 19 (step S11).

Then, if the rotation angle of the motor 4c is not outside the angle range corresponding to the predetermined range Ea to Ed (step S12: NO), the controller 1 returns to step S2 and repeats the above-described processes.

In contrast, if the rotation angle of the motor 4c is outside the angle range corresponding to the predetermined range Ea to Ed (step S12: YES), optical scanning of the predetermined range Ea to Ed is completed. Therefore, the controller 1 reads the detection results of the target Q from the storage unit 9 and outputs the detection results to the vehicle-side ECU 50 via the interface 19 (step S13). Thereafter, while the vehicle 30 is driven, the motor 4c of the optical scanner 4 is kept driven, and the processes from step S1 are repeated.

According to the first embodiment described above, in each of the target detecting devices 10A to 10D, the common LD module 2 and the common PD module 7 are used for detection of the target Q by the object detector 1a and detection of the dirt Da on the optical window 12 by the dirt detector 1b. Therefore, it is not necessary to add a component dedicated to dirt detection to each of the target detecting devices 10A to 10D.

In addition, in each of the target detecting devices 10A to 10D, the operation pattern of the LD module 2 or the PD module 7 differs between detection of the target Q by the object detector 1a and detection of the dirt Da on the optical window 12 by the dirt detector 1b, and object detection and dirt detection are separately performed. In this case, as illustrated in FIG. 10, the predetermined range (Ea) scanned with light by the optical scanner 4 of a certain target detecting device (here, 10A is taken as an example) among the target detecting devices 10A to 10D partially overlaps with the light projecting and receiving ranges (Ec, Ed) of the adjacent target detecting devices (10C, 10D) (F1, F2). Then, this target detecting device (10A) causes the dirt detector 1b to detect the dirt Da on the optical window 12 in the overlapping region (F2) in the predetermined range (Ea), and causes the object detector 1a to detect the target Q in the other regions (Fa, F1). In addition, in the overlapping region (F2) where a certain target detecting device (10A) causes the dirt detector 1b to detect the dirt Da on the optical window 12, an adjacent target detecting device (10C) causes the object detector 1a to detect the target Q. Therefore, it is possible to detect dirt Da on the optical windows 12 of the target detecting devices 10A to 10D without generating a blind spot where the target Q cannot be detected in the predetermined ranges Ea to Ed around the vehicle 30.

Further, by setting the dirt detection regions F1 to F4 (FIG. 10) of the target detecting devices 10A to 10D to fixed regions set in advance, it is possible to reduce the processing load on the controllers 1 and to easily set installation positions of the target detecting devices 10A to 10D on the vehicle 30.

In the example of FIG. 10, entirety of the overlapping regions F1 to F4 near scanning ends among the overlapping regions F1 to F4 near scanning starts and the near scanning ends in the predetermined ranges Ea to Ed of the target detecting devices 10A to 10D are set to the dirt detection regions. However, the present invention is not limited to this. For example, as in a second embodiment described below, part of overlapping regions F1 to F4 may be used as dirt detection regions.

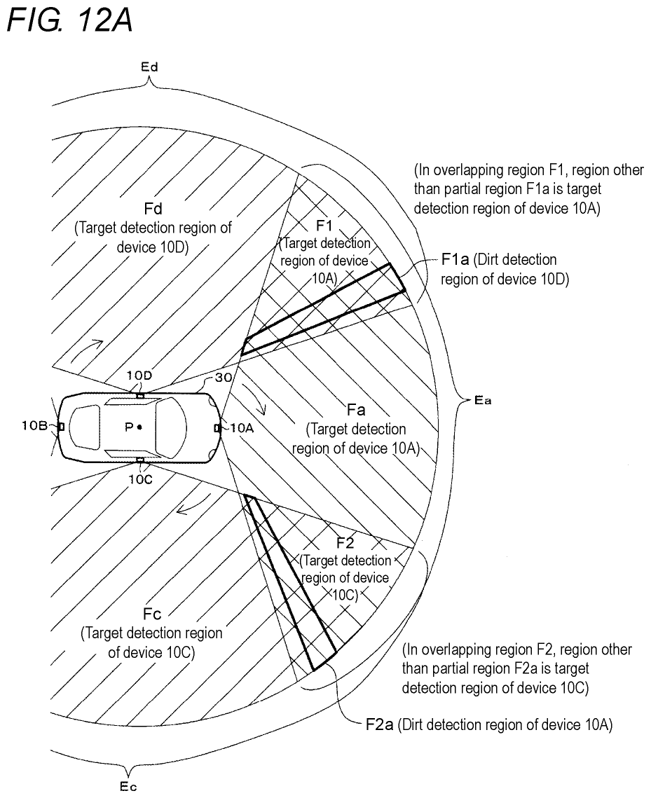

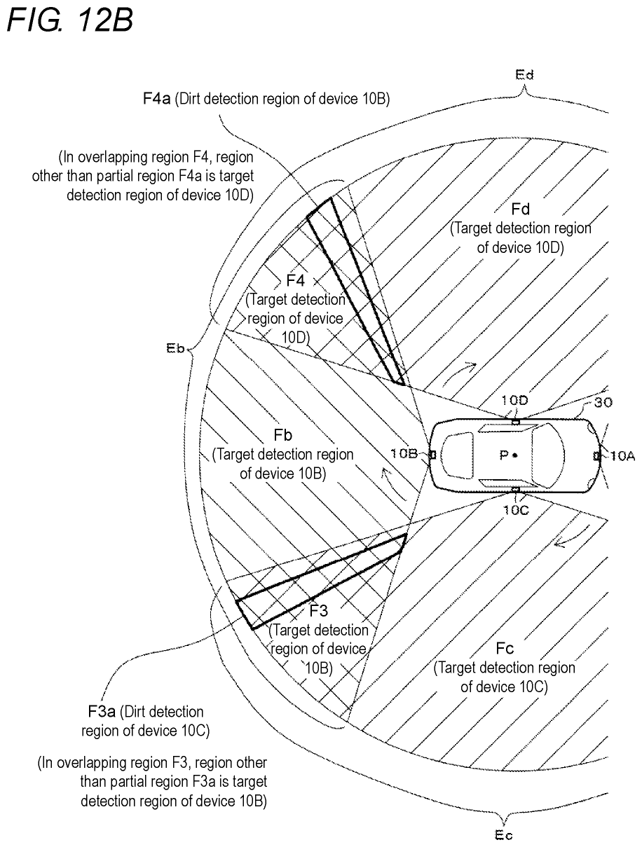

FIGS. 12A and 12B are views illustrating an example of target detection regions and dirt detection regions of target detecting devices 10A to 10D according to a second embodiment. The target detecting devices 10A to 10D cause dirt detectors 1b to detect dirt Da on optical windows 12 in portions F1a to F4a (regions surrounded by thick lines) of overlapping regions F1 to F4 near scanning ends in predetermined ranges Ea to Ed.

Specifically, for example, as illustrated in FIG. 12A, the target detecting device 10A causes the dirt detector 1b to detect the dirt Da on the optical window 12 in the portion F2a of the overlapping region F2 near a scanning end in the predetermined range Ea, and causes an object detector 1a to detect a target Q in regions Fa, F1. As illustrated in FIG. 12B, the target detecting device 10B causes the dirt detector 1b to detect the dirt Da on the optical window 12 in the portion F4a of the overlapping region F4 near a scanning end in the predetermined range Eb, and causes an object detector 1a to detect the target Q in the regions Fb, F3. As illustrated in FIG. 12B, the target detecting device 10C causes the dirt detector 1b to detect the dirt Da on the optical window 12 in the portion F3a of the overlapping region F3 near a scanning end in the predetermined range Ec, and causes an object detector 1a to detect the target Q in the regions Fc, F2. As illustrated in FIG. 12A, the target detecting device 10D causes the dirt detector 1b to detect the dirt Da on the optical window 12 in the portion F1a of the overlapping region F1 near a scanning end in the predetermined range Ed, and causes an object detector 1a to detect the target Q in the regions Fd, F4, as illustrated in FIG. 12B.

That is, the portions F1a to F4a of the overlapping regions F1 to F4 in which the dirt Da on the optical window 12 is detected by a certain target detecting device among the target detecting devices 10A to 10D are also regions where the adjacent target detecting device detects the target Q. In controllers 1 (FIG. 3) of the target detecting devices 10A to 10D, the dirt detection regions F1a to F4a and the target detection regions are set in advance, respectively. In addition, the dirt detection regions F1a to F4a are fixed regions set in advance. The operation of the target detecting devices 10A to 10D of the second embodiment is similar to the operation of the first embodiment illustrated in FIG. 11.

As in the above second embodiment, since the dirt detectors 1b detect dirt Da on the optical windows 12 in the portions Fla to F4a of the overlapping regions F1 to F4 in the predetermined ranges Ea to Ed of the target detecting devices 10A to 10D, the dirt detection regions of the target detecting devices 10A to 10D can be reduced, and the detection regions of the target Q can be expanded.

Examples of FIGS. 10, and 12A and 12B illustrate the examples in which the dirt detection regions F1 to F4 and Fla to F4a of the target detecting devices 10A to 10D are fixed regions; however, the present invention is not limited to them. For example, as in a third embodiment described below, dirt detection regions of target detecting devices 10A to 10D may be variable regions that vary at predetermined timing.

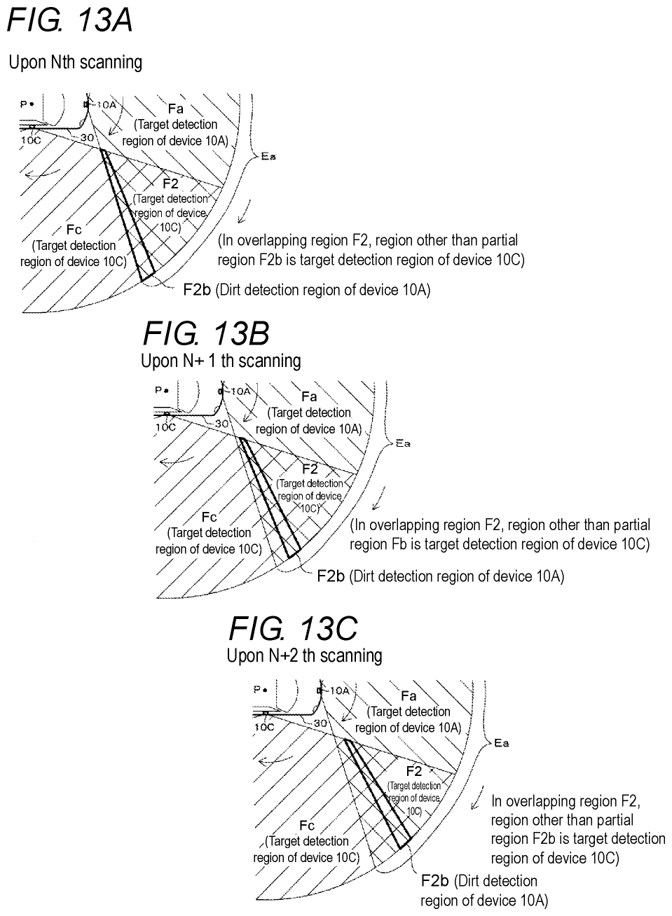

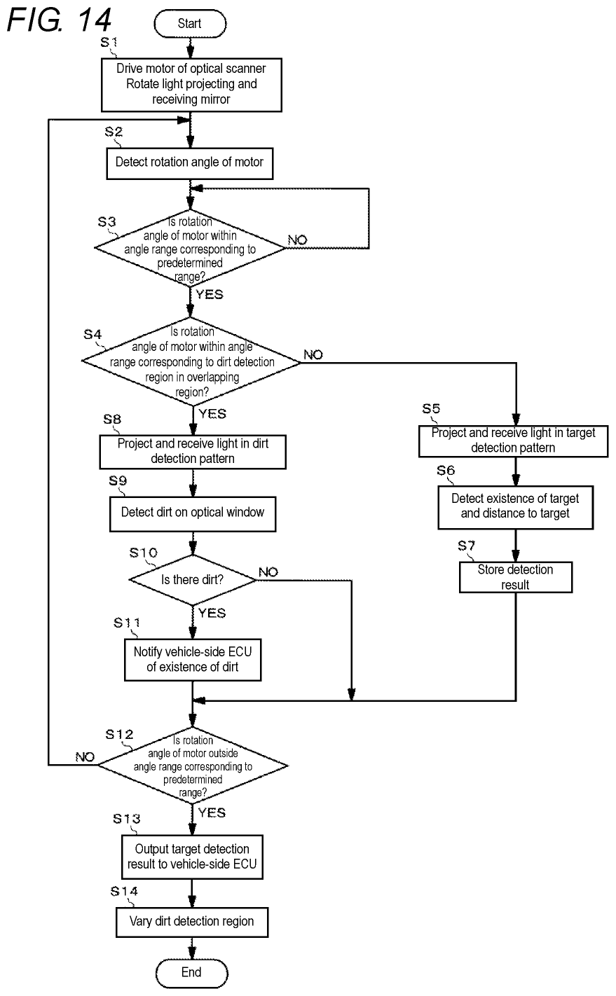

FIGS. 13A to 13C are views illustrating target detection regions and dirt detection regions of target detecting devices according to a third embodiment. Here, part of detection regions of target detecting devices 10A, 10C is illustrated. FIG. 14 is a flowchart illustrating operation of each of the target detecting devices 10A to 10D according to the third embodiment.

As illustrated in FIGS. 13A to 13C, a region F2b where the target detecting device 10A causes a dirt detector 1b to detect dirt Da on an optical window 12 is set in part of an overlapping region F2 near a scanning end in a predetermined range Ea scanned with light by an optical scanner 4. Then, every time the target detecting device 10A causes the optical scanner 4 to scan the predetermined range Ea with light (every time mirrors 4a, 4b illustrated in FIG. 4 and the like make one rotation), the dirt detection region F2b varies by a predetermined angle within the overlapping region F2. Specifically, as illustrated in FIGS. 13A to 13C, every time the number N of times of scanning increases by one, the dirt detection region F2b varies by a predetermined angle in the overlapping region F2 in the direction opposite to the optical scanning direction (counterclockwise direction with the center P of a vehicle 30 as the rotation center).

In addition, for example, the dirt detection region F2b may vary by a predetermined angle from one end part (scanning end part of FIG. 13A) of the overlapping region F2. When the dirt detection region F2b reaches the other end part (scanning intermediate part) of the overlapping region F2, the dirt detection region F2b may vary by a predetermined angle again from the one end part to the other end part of the overlapping region F2. Alternatively, the dirt detection region F2b may vary by a predetermined angle from the other end part to the one end part of the overlapping region F2.

In the third embodiment, dirt detection regions F1b, F3b, F4b (not illustrated) of the other target detecting devices 10B to 10D also vary similarly to the dirt detection region F2b of the above-described target detecting device 10A.

The controllers 1 of the target detecting devices 10A to 10D vary the dirt detection regions of the target detecting devices 10A to 10D, respectively. For example, in FIG. 14, each of the controllers 1 of the target detecting devices 10A to 10D executes each process from step S1 similarly in the first embodiment (FIG. 11) described above. Then, after step S7 or step S11, when the rotation angle of a motor 4c is outside the angle range corresponding to the predetermined range Ea to Ed (step S12: YES), and scanning of the predetermined range Ea to Ed with light is completed, the controller 1 outputs the detection result of a target Q to a vehicle-side ECU 50 (step S13). In addition, the controller 1 varies the dirt detection region by a predetermined angle (step S14, FIGS. 13A to 13C). Thereafter, while a vehicle 30 is driven, the processes from step S1 are repeated. Then, in step S14, the controller 1 varies the dirt detection region by the predetermined angle again.

As in the above third embodiment, in the target detecting devices 10A to 10D, by varying the dirt detection regions F1b to F4b in the overlapping regions F1 to F4 in the predetermined ranges Ea to Ed, it is possible to vary the regions where an object detector 1a detects the target Q. Therefore, even if the target Q temporarily exists in one of the dirt detection regions F1b to F4b, the object detector 1a can more reliably detects the target Q during next scanning. In addition, the dirt detector 1b can more easily detect minute dirt attached to part of the optical window 12.

The present invention can adopt various embodiments other than the above-described embodiments. For example, the above embodiments illustrate examples in which entirety or part of the overlapping regions F1 to F4 near scanning ends in the predetermined ranges Ea to Ed of the target detecting devices 10A to 10D are set to the dirt detection regions of the optical windows 12. However, the present invention is not limited to this. Other than this, for example, entirety or part of overlapping regions F1 to F4 near scanning starts in predetermined ranges Ea to Ed may be set to dirt detection regions of the optical windows 12.

In addition, the above embodiments illustrate examples in which the target detecting devices 10A to 10D are installed at the front part, the rear part, the right side, and the left side of the vehicle 30; however, the present invention is not limited to this. Installation positions, installation intervals, installation directions, and the number of target detecting devices installed may be set as appropriate. In addition, the size, the extending direction, and the like of range that a target detecting device scans with light, overlapping regions set when adjacent target detecting devices perform optical scanning, a dirt detection region of an optical window, and a target detection region may be appropriately set.

In addition, the embodiments illustrated in FIGS. 11 and 14 illustrate examples in which immediately after the dirt detector 1b detects that dirt Da exists on the optical window 12 (step S10: YES), the vehicle-side ECU 50 is notified of this (Step S11); however, the present invention is not limited to this. Other than this, for example, when a dirt detector 1b detects that dirt Da exists on an optical window 12, this result may be stored in a storage unit 9, and then after optical scanning of predetermined ranges Ea to Ed are completed (step S12: YES), a vehicle-side ECU 50 may be notified of the fact that the dirt Da exists on the optical window 12 together with the detection result of a target Q.

Further, the embodiment illustrated in FIG. 14 illustrates an example in which the dirt detection region varies (step S14) every time optical scanning of the predetermined range Ea to Ed is completed (step S12: YES); however, the present invention is not limited to this. Other than this, for example, a dirt detection region may vary every time optical scanning of a predetermined range Ea to Ed is completed a predetermined number of times or every predetermined time has passed. In addition, a dirt detection region may be changed at timings other than these timings.

In addition, the above embodiments illustrate examples in which each of the target detecting devices 10A to 10D includes the LD module 2 having the four LD₍₁₎ to LD₍₄₎, and the PD module 7 having the PD in which the four light receiving regions Ra₍₁₎ to Ra₍₄₎ are one-dimensionally arranged; however, the present invention is not limited to this. The number of installed LDs and the number of provided light receiving regions of a PD module may be any number of two or more. In addition, the number of installed LD modules and PD modules may be two or more. Further, a target detecting device may include a light emitter having another light emitting element and a light receiver having another light receiving element.

In addition, the above embodiments illustrate examples in which existence of the dirt Da on the optical window 12 which is a light projecting and receiving port is detected; however, the present invention is not limited to them. Other than this, for example, a light projecting optical window serving as a light projecting port and a light receiving optical window serving as a light receiving port may be separately provided on a case 11, and existence of dirt on at least one of the light projecting optical window the light receiving optical window may be detected.

In addition, the above embodiments illustrate the target detecting system 100 including the target detecting devices 10A to 10D which have identical structures; however, the present invention is not limited to this, and a target detecting system may include a plurality of target detecting devices having different configurations.

Further, the above embodiments describe examples in which the present invention is applied to the in-vehicle target detecting device and the in-vehicle target detecting system. However, the present invention can also be applied to a target detecting device and a target detecting system for another intended use.

1. A target detecting device comprising:
a light emitter configured to emit light;
a light receiver configured to receive light;
an optical scanner configured to scan a predetermined range with light emitted from the light emitter, to perform scanning with light reflected by a target in the predetermined range, and to guide the light to the light receiver;
an object detector configured to detect one of existence of the target and a distance to the target according to a light reception state of the light receiver;
a case configured to house the light emitter, the light receiver, and the optical scanner;
an optical window formed of light-transmissive material that transmits light and configured to serve as one of a light projecting port and a light receiving port to an inside and an outside of the case; and
a dirt detector configured to detect existence of dirt on the optical window according to a light reception state of the light receiver,
wherein an operation pattern of one of the light emitter and the light receiver differs between detection of the target by the object detector and detection of dirt on the optical window by the dirt detector, and the detection of the target and the detection of the dirt are performed separately,
wherein the predetermined range which is scanned with light by the optical scanner partially overlaps with a range where another target detecting device detects a target, and
wherein the detection of the dirt on the optical window by the dirt detector is performed in an overlapping region in the predetermined range, and the detection of the target by the object detector is performed in another region in the predetermined range.

2. The target detecting device according to claim 1, wherein the detection of the dirt on the optical window by the dirt detector is performed in a partial region of the overlapping region in the predetermined range.

3. The target detecting device according to claim 2, wherein the partial region where the detection of the dirt is performed is one of a fixed region set in advance and a variable region that varies by a predetermined angle at predetermined timing.

4. The target detecting device according to claim 1,
wherein the light emitter includes a plurality of light emitting elements,
wherein the light receiver has a plurality of light receiving regions corresponding to the plurality of light emitting elements, respectively, and
wherein an operation pattern of one of the plurality of light emitting elements and the plurality of light receiving elements differs between the detection of the target and the detection of the dirt.

5. A target detecting system comprising a plurality of target detecting devices configured to detect one of existence of a target and a distance to a target in a predetermined range,
at least one of the plurality of target detecting devices being the target detecting device according to claim 1.

6. The target detecting system according to claim 5,
wherein the plurality of target detecting devices is installed at a predetermined interval on a moving body,
wherein the predetermined range scanned with light by the optical scanner of one of the plurality of target detecting devices partially overlaps with the predetermined range scanned with light by the optical scanner of another of the plurality of target detecting devices, the one of the plurality of target detecting devices and the other of the plurality of target detecting devices being adjacent to each other, and
wherein in the overlapping region in the predetermined range, the one of the plurality of target detecting devices causes the dirt detector to detect the dirt on the optical window, and the other of the plurality of target detecting devices causes the object detector to detect the target.
